(19) United States
(12) Patent Application Publication
(10) Pub. No.: US 2020/0159184 A1
(43) Pub. Date: May 21, 2020

(54) PARAMETER SETTING DEVICE, SYSTEM, AND PARAMETER SETTING METHOD

(71) Applicant: FANUC CORPORATION, Yamanashi (JP)

(72) Inventors: Naoya TAKEUCHI, Yamanashi-ken (JP); Rikizou WATANABE, Yamanashi-ken (JP)

(21) Appl. No.: 16/677,858

(22) Filed: Nov. 8, 2019

(30) Foreign Application Priority Data
Nov. 15, 2018 (JP) 2018-214658

(51) Int. Cl. G05B 19/409; G05B 19/408; G05B 19/401

(52) U.S. Cl. CPC G05B 19/409; G05B 19/4083; G05B 2219/37357; G05B 2219/31294; G05B 19/401

(57) ABSTRACT

A parameter setting device is configured to set a parameter relating to a speed of a table of a machine tool in accordance with the weight of an object placed on the table. The parameter setting device includes: an amount-of-strain obtaining unit configured to obtain the amount of strain of the table; a storage unit storing the parameter corresponding to the amount of strain; and a parameter setting unit configured to set, by using the storage unit, the parameter based on the amount of strain obtained by the amount-of-strain obtaining unit with the table standing still.

### CROSS-REFERENCE TO RELATED APPLICATION

This application is based upon and claims the benefit of priority from Japanese Patent Application No. 2018-214658 filed on Nov. 15, 2018, the contents of which are incorporated herein by reference.

### BACKGROUND OF THE INVENTION

### Field of the Invention

The present invention relates to a parameter setting device for setting a parameter relating to the speed of a table of a machine tool, a system having the parameter setting device, and a parameter setting method.

### Description of the Related Art

In general, a machine tool performs machining operation with a machining jig, an additional axis table, etc. in addition to the workpiece being mounted on a table of the machine tool. It is therefore necessary to set parameters, such as a time constant relating to the speed of the table, in consideration of the weight of the objects mounted on the table. Conventionally, as described in Japanese Laid-Open Patent Publication No. 08-314531, in the machine tools, such parameters have been manually set.

### SUMMARY OF THE INVENTION

When parameters relating to the table speed are manually set as described in Japanese Laid-Open Patent Publication No. 08-314531, there is a fear that the parameters might be set without considering the weight of the objects placed on the table, possibly resulting in parameter values inappropriate for the actual weight of the objects on the table. Performing machining operation with parameter settings corresponding to a heavier weight than the weight of the objects on the table may unnecessarily lengthen machining cycle time disadvantageously. On the other hand, performing machining operation with parameter settings corresponding to a lighter weight than the weight of the objects on the table may damage the machine tool, deteriorate machining accuracy to the workpiece, and shorten the life of the machine tool disadvantageously.

Accordingly, an object of the present invention is to provide a parameter setting device that is capable of automatically setting a parameter relating to the speed of the table in a manner appropriate for the weight of objects placed thereon, a system, and a parameter setting method.

According to a first aspect of the present invention, there is provided a parameter setting device that is configured to set a parameter relating to a speed of a table of a machine tool in accordance with a weight of an object placed on the table. The parameter setting device includes: an amount-of-strain obtaining unit configured to obtain an amount of strain of the table; a storage unit that stores the parameter corresponding to the amount of strain; and a parameter setting unit configured to set, by using the storage unit, the parameter based on the amount of strain obtained by the amount-of-strain obtaining unit with the table standing still.

According to a second aspect of the present invention, there is provided a system including: the parameter setting device described above; and a driving control unit configured to perform a speed control of the table based on the parameter set by the parameter setting unit.

According to a third aspect of the present invention, there is provided a parameter setting method for setting a parameter relating to a speed of a table of a machine tool in accordance with a weight of an object placed on the table. The parameter setting method includes: an amount-of-strain obtaining step of obtaining an amount of strain of the table; and a parameter setting step of setting, by using a storage unit storing the parameter corresponding to the amount of strain, the parameter based on the amount of strain obtained in the amount-of-strain obtaining step with the table standing still.

According to the present invention, it is possible to automatically set a parameter relating to the speed of the table appropriately for the weight of the objects placed thereon.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a diagram illustrating the configuration of a system according to an embodiment;

FIG. 2 is a diagram for explaining a measurement unit composed of an air micro sensor;

FIG. 3 is a graph showing a relation between the amount of strain and time constant;

FIG. 4 is a flowchart illustrating a parameter setting method by the parameter setting device;

FIG. 5 is a diagram showing the configuration of a system according to a first modification;

FIG. 6 is a diagram showing the configuration of a system according to a second modification;

FIG. 7 is a diagram showing the configuration of a system according to a third modification;

FIG. 8 is a diagram for explaining a measurement unit composed of contact sensors according to a fourth modification;

FIG. 9 is a diagram showing the configuration of a system according to a fifth modification;

FIG. 10 is a diagram showing the configuration of a system according to a sixth modification; and

FIG. 11 is a diagram for explaining a measurement unit composed of a magnet and a Hall element according to a seventh modification.

### DESCRIPTION OF THE PREFERRED EMBODIMENTS

The parameter setting device, system, and parameter setting method according to the present invention will now be described in detail in conjunction with preferred embodiments while referring to the accompanying drawings.

### EMBODIMENT

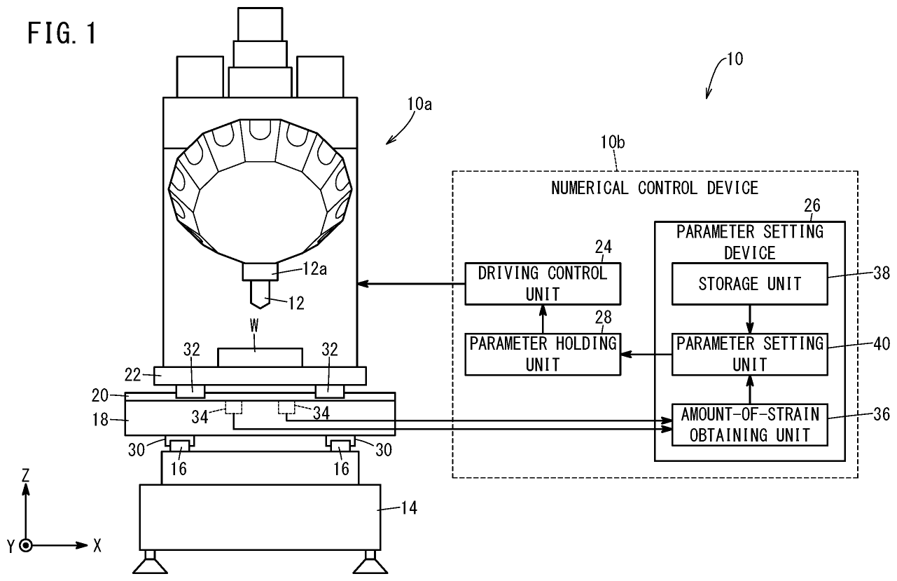

FIG. 1 is a diagram illustrating the configuration of a system 10 according to an embodiment. The system 10 is a machine tool that includes a machine tool body 10a and a numerical control device 10b. The system 10 may hereinafter be also referred to as a machine tool 10. The machine tool body 10a includes a tool 12, a spindle 12a, a bed 14, Y-axis rails 16, a saddle 18, X-axis rails 20, and a table 22. The numerical control device 10b controls the relative position between the tool 12 and the table 22 of the machine tool body 10a, whereby a workpiece W on the table 22 is machined. The numerical control device 10b includes a driving control unit 24, a parameter setting device 26, and a parameter holding unit 28.

The Y-axis rails 16 are disposed on the bed 14 so as to extend in the Y-axis direction. The saddle 18 has movement members 30 that are capable of linear movement on the Y-axis rails 16 in the Y-axis direction, and can thus move in the Y-axis direction on the Y-axis rails 16. The saddle 18 can be moved in the Y-axis direction by driving of a Y-axis motor (not shown) that is controlled by the driving control unit 24.

The X-axis rails 20 are disposed on the saddle 18 so as to extend in the X-axis direction. The table 22 has movement members 32 that are capable of linear movement on the X-axis rails 20 in the X-axis direction and can thus move in the X-axis direction on the X-axis rails 20. The table 22 can be moved in the X-axis direction by driving of an X-axis motor (not shown) that is controlled by the driving control unit 24. The saddle 18 supports the table 22 in this way, and the driving control unit 24 enables the workpiece W on the table 22 to move in the X-axis direction and Y-axis direction.

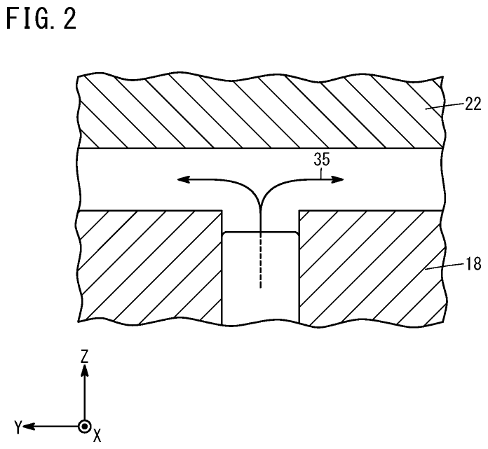

A plurality of measurement units 34 are provided at an upper surface of the saddle 18. That is, the measurement units 34 are disposed at multiple positions of the saddle 18 so as to obtain the amounts of strain at the multiple positions of the table 22. A specific example of the measurement units 34 is an air micro sensor (air gap sensor for precise machining). FIG. 2 is a diagram illustrating the measurement unit 34 composed of an air micro sensor. The air micro sensor provided at the upper surface of the saddle 18 as a measurement unit 34 blows air 35 against the bottom surface of the table 22 to measure the amount of change in air pressure.

The parameter setting device 26 includes an amount-of-strain obtaining unit 36, a storage unit 38, and a parameter setting unit 40.

The amount-of-strain obtaining unit 36 obtains the amount of strain of the table 22 on the basis of the measurement values measured by the measurement units 34. The amount of change in air pressure, which is a measurement value measured by the air micro sensor serving as a measurement unit 34, corresponds to the amount of change in the distance between the table 22 and the saddle 18. Further, the amount of change in the distance between the table 22 and the saddle 18 corresponds to the amount of strain of the table 22 corresponding to the weight of the objects placed on the table 22, so that the amount-of-strain obtaining unit 36 can obtain the amount of strain of the table 22 from the amount of change in air pressure given as the measurement value. Since the measurement units 34 are disposed at multiple positions, the amount-of-strain obtaining unit 36 can obtain multiple amounts of strain at the multiple positions of the table 22.

The storage unit 38 stores a parameter or parameters associated with the amount of strain. Now, the parameter(s) are those relating to a moving speed (speed) of the table 22. Specific examples of the parameters include a time constant for determining acceleration of the table 22, a maximum speed of the table 22, and so on. The parameter(s) may include at least one of the time constant and maximum speed, or may include the time constant and the maximum speed. Causing the machine tool 10 to perform appropriate machining operation requires that the parameter(s) relating to the moving speed of the table 22 be determined in accordance with the weight of the objects placed on the table 22. The storage unit 38 may store parameters respectively for the X-axis direction and the Y-axis direction.

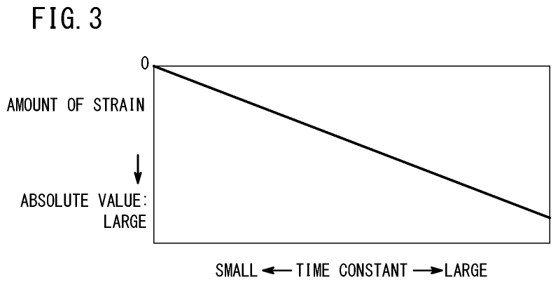

FIG. 3 is a graph illustrating a relation between the amount of strain and time constant. The vertical axis represents the amount of strain, where the amount of strain has its upper limit at strain=0 and exhibits negative values with downwardly increasing absolute values. The horizontal axis represents the time constant, where the value increases rightward and decreases leftward. The absolute value of the amount of strain increases as the weight of the objects on the table 22 increases, and the time constant needs to be enlarged as the weight of the objects on the table 22 increases. Accordingly, as shown in FIG. 3, it is necessary to enlarge the time constant as the absolute value of the amount of strain increases. This relation between the amount of strain and time constant is previously stored in the storage unit 38 as a parameter associated with the amount of strain. Since the parameter can be a maximum speed of the table 22 as mentioned earlier, a relation between the amount of strain and the maximum speed may be previously stored in the storage unit 38 as a parameter associated with the amount of strain. In the relation between the amount of strain and the maximum speed, the absolute value of the maximum speed is decreased as the absolute value of the amount of strain increases.

The parameter setting unit 40 sets the parameter(s) into the parameter holding unit 28. Specifically, the parameter setting unit 40 obtains from the storage unit 38 a parameter corresponding to the amount of strain that the amount-of-strain obtaining unit 36 has obtained with the table 22 standing still, and sets the obtained parameter into the parameter holding unit 28. That is, the parameter setting unit 40 sets in the parameter holding unit 28 a time constant or a maximum speed as the parameter corresponding to the amount of strain obtained, by using a relation between the amount of strain and time constant or a relation between the amount of strain and maximum speed stored in the storage unit 38.

Now, since the amount-of-strain obtaining unit 36 obtains the amounts of strain from the measurement units 34 located at multiple positions, the parameter setting unit 40 sets a parameter corresponding to the average value of the multiple amounts of strain, the largest amount of strain among the multiple amounts of strain (the maximum amount of strain), or the like. When the parameter setting unit 40 calculates the average value of the multiple amounts of strain, it may calculate the average value while weighting each of the multiple amounts of strain according to a predetermined condition. Incidentally, only one measurement unit 34, instead of multiple measurement units 34, may be provided at a predetermined position. In this case, the parameter setting unit 40 is adapted to set a parameter in accordance with the amount of strain measured by the one measurement unit 34.

The parameter holding unit 28 is a storage medium that holds (stores) parameters. The driving control unit 24 controls the speed of the table 22 on the basis of the set parameters held in the parameter holding unit 28. That is, the driving control unit 24 controls the speed of the table 22 according to the time constant, the maximum speed set by the parameter setting unit 40, so that the workpiece W is machined. The driving control unit 24 performs a speed control of the table 22 in the X-axis direction and a speed control in the Y-axis direction on the basis of the set parameters.

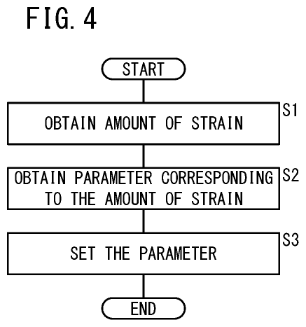

FIG. 4 is a flowchart illustrating a parameter setting method performed by the parameter setting device 26. First, the amount-of-strain obtaining unit 36 obtains the amounts of strain of the table 22 on the basis of the measurements performed by the measurement units 34 with the table 22 standing still (step S1).

Next, the parameter setting unit 40 obtains from the storage unit 38 a parameter that corresponds to the amount of strain obtained by the amount-of-strain obtaining unit 36 at step S1 (step S2).

Then, the parameter setting unit 40 sets the parameter obtained at step S2 into the parameter holding unit 28 (step S3). The process of automatically setting a parameter is thus completed.

According to the parameter(s) set in the parameter holding unit 28 at step S3, the driving control unit 24 controls the speed of the table 22 to thereby drive the table 22, so that the workpiece W can be machined suitably.

According to the parameter setting device 26, the system 10, and the parameter setting method according to the embodiment, it is possible to automatically set a parameter relating to the speed of the table 22 of the machine tool 10 in a manner appropriate for the weight of objects placed thereon, without moving the table 22. This enables the speed of the table 22 to be controlled appropriately in accordance with the weight of the objects placed thereon. This in turn makes it possible to optimize machining cycle time, enhance machining accuracy to the workpiece W without damaging the machine tool 10, and lengthen the life of the machine tool 10.

### [Modifications]

The above-described embodiment can be modified as described below.

### (First Modification)

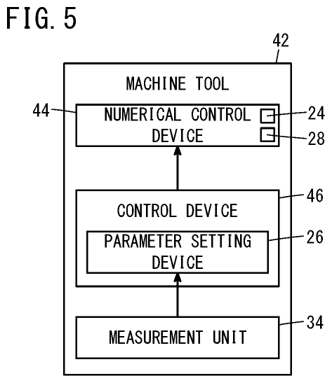

FIG. 5 is a diagram illustrating the configuration of a system 42 according to a first modification. The system 42 is a machine tool and will hereinafter be referred to as a machine tool 42. The machine tool 42 is configured similarly to the machine tool 10 of FIG. 1. However, in the machine tool 42, a control device 46 that is different from the numerical control device 44 includes the parameter setting device 26. Providing the control device 46, such as a personal computer or microcomputer different from the numerical control device 44, with the function of the parameter setting device 26 makes it possible to improve the maintenance workability without considerably changing the configuration of the numerical control device 44. The numerical control device 44 here includes the driving control unit 24 and the parameter holding unit 28.

### (Second Modification)

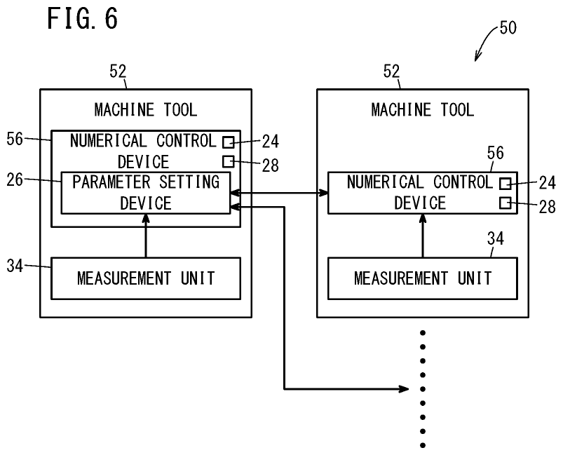

FIG. 6 is a diagram illustrating the configuration of a system 50 according to a second modification. The system 50 is a machine tool system that includes multiple machine tools 52 each including a numerical control device 56. In the second modification, the numerical control device 56 of one of the multiple machine tools 52 includes the parameter setting device 26. Here, each machine tool 52 includes the measurement units 34, and each numerical control device 56 includes the driving control unit 24 and the parameter holding unit 28.

In the second modification, the parameter setting device 26 sets parameters for each individual machine tool 52 on the basis of the amount of strain obtained from the measurement units 34 of each of the multiple machine tools 52. In this way, even when the system 50 includes an increased number of machine tools 52, the parameter setting device 26 provided in one numerical control device 56 can set parameters for each individual machine tool 52 in accordance with the weight of the objects placed on the table 22 of each of all machine tools 52. Thus, even with a machine tool system including multiple machine tools 52, it is possible to automatically set appropriate parameters relating to the speed of the table 22 of each machine tool 52. The storage unit 38 of the parameter setting device 26 may store a parameter associated with the amount of strain as shown in FIG. 3 for each individual machine tool 52.

### (Third Modification)

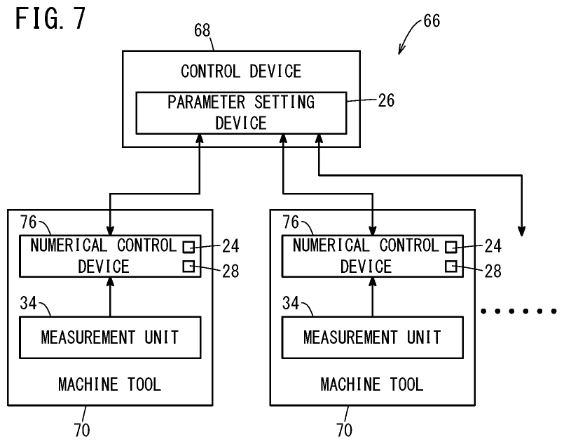

FIG. 7 is a diagram illustrating the configuration of a system 66 according to a third modification. The system 66 is a machine tool system that includes a control device 68 and multiple machine tools 70 each including a numerical control device 76. In the third modification, the control device 68, such as a personal computer or microcomputer different from the numerical control devices 76, includes the parameter setting device 26. Here, the machine tools 70 each include the measurement units 34 and each numerical control device 76 includes the driving control unit 24 and the parameter holding unit 28.

In the third modification, the parameter setting device 26 sets parameters for each individual machine tool 70 on the basis of the amount of strain obtained from the measurement units 34 of each of the multiple machine tools 70. In this way, even when the system 66 includes an increased number of machine tools 70, the parameter setting device 26 provided in the control device 68 can set parameters for each individual machine tool 70 in accordance with the weight of the objects placed on the table 22 of each of all machine tools 70. Thus, even with a machine tool system including multiple machine tools 70, it is possible to automatically set parameters relating to the speed of the table 22 of each machine tool 70 in an appropriate manner without considerably changing the configuration of the numerical control devices 76. The storage unit 38 of the parameter setting device 26 may store a parameter associated with the amount of strain as shown in FIG. 3 for each individual machine tool 70.

### Fourth Embodiment

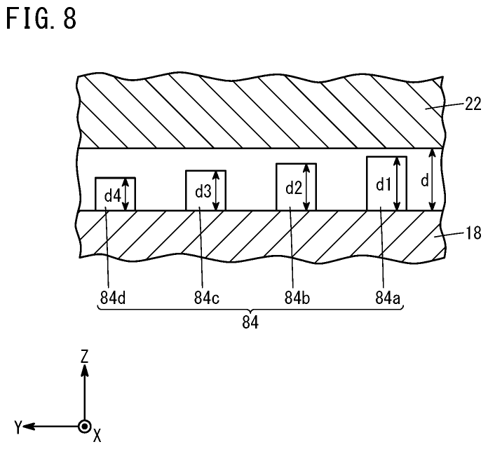

FIG. 8 is a diagram illustrating a measurement unit 84 formed of contact sensors according to a fourth modification. In the fourth modification, the measurement units 34 of the system 10 of FIG. 1 are replaced by measurement units 84 including contact sensors. Each measurement unit 84 includes a plurality of contact sensors 84a to 84d. The configuration is the same as that of FIG. 1 except for the measurement units 84. The amount-of-strain obtaining unit 36 obtains the amount of strain on the basis of the measurement values measured by the measurement units 84. The contact sensors 84a to 84d are provided on the saddle 18. They are sensors that turn on when a distance d between the table 22 and the saddle 18 becomes smaller than a certain value and otherwise remain off. Specifically, the contact sensor 84a turns on when d≤d1, the contact sensor 84b turns on when d≤d2, the contact sensor 84c turns on when d≤d3, and the contact sensor 84d turns on when d≤d4. Here, the relation d1>d2>d3>d4 holds. The amount-of-strain obtaining unit 36 is provided with measurement values indicating whether the contact sensors 84a to 84d are in an on state or an off state. Thus, if the contact sensors 84a and 84b turn on and the contact sensors 84c and 84d remain off, an estimation can be made as d2≥d>d3, whereby the amount-of-strain obtaining unit 36 can obtain the amount of strain of the table 22 through estimation. The measurement unit 84 can roughly estimate the value (small and large) of the amount of strain if it includes at least two contact sensors in correspondence with two different distances.

### (Fifth Modification)

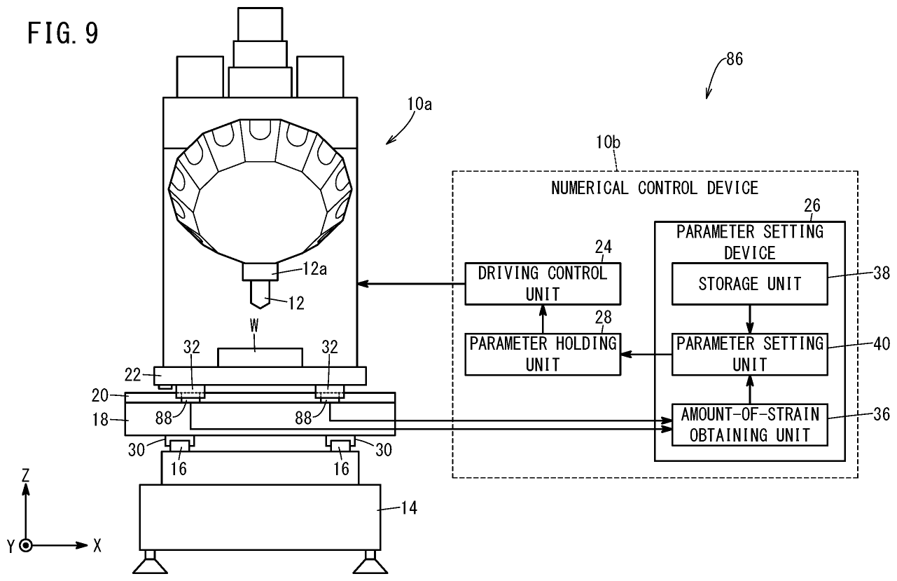

FIG. 9 is a diagram illustrating the configuration of a system 86 according to a fifth modification. In the system 86, the measurement units 34 of the system 10 of FIG. 1 are replaced by measurement units 88 formed of a strain gauge sensor. The measurement units 88 formed of a strain gauge sensor are provided on the X-axis rails 20 at positions where the load of the table 22 acts through the movement members 32 when the table 22 is at rest. It is thus possible to measure the weight of the objects placed on the table 22 as the amount of strain. Four measurement units 88 of strain gauge sensors are provided in all, including those disposed at the X-axis rail 20 that is hidden on the back side of the drawing sheet. The amount-of-strain obtaining unit 36 can obtain the amounts of strain measured by the measurement units 88.

### (Sixth Modification)

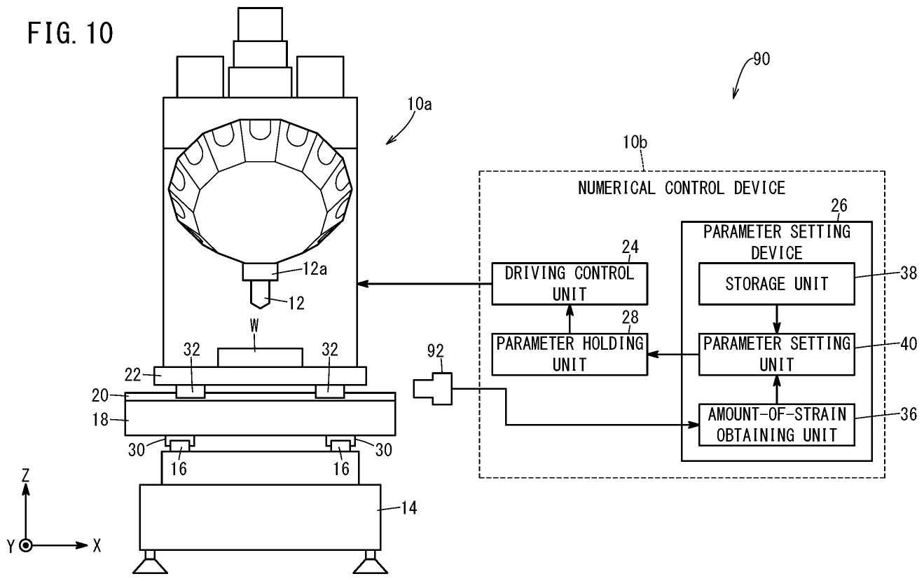

FIG. 10 is a diagram illustrating the configuration of a system 90 according to a sixth modification. In the system 90, the measurement units 34 of the system 10 of FIG. 1 are replaced by a measurement unit 92 that is composed of a vision camera. The measurement unit 92 of a vision camera can take images of an area between the table 22 and the saddle 18 to recognize and measure a distance between the table 22 and the saddle 18. On the basis of the distance between the table 22 and the saddle 18 measured by the measurement unit 92, the amount-of-strain obtaining unit 36 can obtain the amount of strain of the table 22.

### (Seventh Modification)

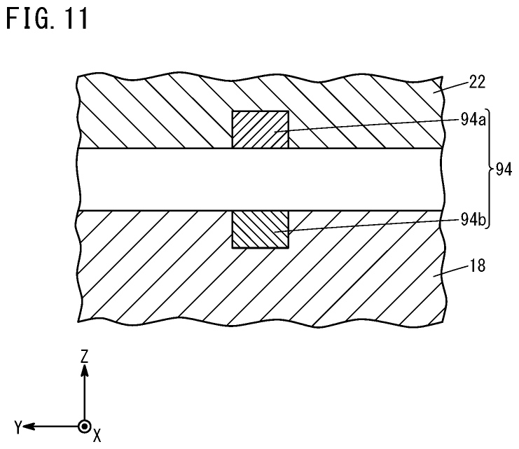

FIG. 11 is a diagram illustrating a measurement unit 94 composed of a magnet 94a and a Hall element 94b according to a seventh modification. In the seventh modification, the measurement units 34 in the system 10 of FIG. 1 are replaced by measurement units 94. Each measurement unit 94 is formed of the magnet 94a and Hall element 94b. The configuration is the same as that of FIG. 1 except for the measurement units 94. The amount-of-strain obtaining unit 36 obtains the amounts of strain on the basis of the measurement values measured by the measurement units 94. The magnet 94a is disposed at a lower surface of the table 22 and the Hall element 94b is disposed at an upper surface of the saddle 18, but the Hall element 94b may be disposed at the lower surface of the table 22, with the magnet 94a disposed at the upper surface of the saddle 18. With the measurement unit 94 configured in this way, the Hall element 94b detects, as Hall current, the strength of the magnetic field that depends on the distance between the table 22 and the saddle 18. Thus, the amount-of-strain obtaining unit 36 can obtain the amount of strain of the table 22 on the basis of the Hall current measured by the Hall element 94b of the measurement unit 94.

[Invention Obtained from Embodiments]

The invention that can be grasped from the above-described embodiments and modifications will be recited below.

### <First Invention>

The parameter setting device (26) is configured to set a parameter relating to a speed of a table (22) of a machine tool (10, 42, 52, 70) in accordance with the weight of an object placed on the table (22). The parameter setting device (26) includes: an amount-of-strain obtaining unit (36) configured to obtain the amount of strain of the table (22); a storage unit (38) that stores the parameter corresponding to the amount of strain; and a parameter setting unit (40) configured to set, by using the storage unit (38), the parameter based on the amount of strain obtained by the amount-of-strain obtaining unit (36) with the table (22) standing still.

Thus, it is possible to automatically set a parameter relating to the speed of the table (22) of the machine tool (10, 42, 52, 70) in a manner appropriate for the weight of the objects placed thereon, without moving the table (22). This makes it possible to perform a suitable speed control of the table (22) in accordance with the weight of the objects placed thereon. This in turn makes it possible to optimize the machining cycle time, improve the machining accuracy to the workpiece (W) without damaging the machine tool (10, 42, 52, 70), and to lengthen the life of the machine tool (10, 42, 52, 70).

The parameter may include at least one of a time constant and a maximum speed.

The amount-of-strain obtaining unit (36) may be configured to obtain the amounts of strain at multiple positions of the table (22). The parameter setting unit (40) may be configured to set the parameter in accordance with an average value of the amounts of strain at the multiple positions. It is thus possible to set a parameter that more precisely reflects the weight of the objects placed on the table (22).

### <Second Invention>

A system (10, 42, 50, 66, 86, 90) includes: the parameter setting device (26) described above; and a driving control unit (24) configured to perform a speed control of the table (22) based on the parameter set by the parameter setting unit (40).

Thus, it is possible to automatically set a parameter relating to the speed of the table (22) of the machine tool (10, 42, 52, 70) in a manner appropriate for the weight of the objects placed thereon, without moving the table (22). This makes it possible to perform a suitable speed control of the table (22) in accordance with the weight of the objects placed thereon. This in turn makes it possible to optimize the machining cycle time, improve the machining accuracy to the workpiece (W) without damaging the machine tool (10, 42, 52, 70), and to lengthen the life of the machine tool (10, 42, 52, 70).

The system (10, 42) may be the machine tool (10, 42).

The numerical control device (10b) of the machine tool (10) may include the parameter setting device (26) and the driving control unit (24).

The numerical control device (44) of the machine tool (42) may include the driving control unit (24), and the control device (46) different from the numerical control device (44) may include the parameter setting device (26). It is thus possible to improve the maintenance workability without considerably changing the configuration of the numerical control device (44).

The system (50) may further include a plurality of the machine tools (52) each including a numerical control device (56). Each of the numerical control devices (56) may include the driving control unit (24), and the numerical control device (56) of one of the plurality of machine tools (52) may include the parameter setting device (26). With this configuration, even with a machine tool system including a plurality of machine tools (52), it is possible to automatically set appropriate parameters relating to the speeds of the tables (22) of the individual machine tools (52).

The system (66) may further include a plurality of the machine tools (70) each including a numerical control device (76). Each of the numerical control devices (76) may include the driving control unit (24), and a control device (68) different from the numerical control devices (76) may include the parameter setting device (26). Owing thereto, even with a machine tool system including a plurality of machine tools (70), it is possible to automatically set appropriate parameters relating to the speeds of the tables (22) of the individual machine tools (70) without considerably changing the configuration of the numerical control devices (76).

The amount-of-strain obtaining unit (36) may be configured to obtain the amount of strain based on a measurement value measured by a measurement unit (34, 84, 88, 92, 94) provided in the machine tool.

The measurement unit (34, 84, 88, 92) may be comprised of an air micro sensor, a contact sensor, a strain gauge sensor, or a vision camera.

The measurement unit (94) may include a magnet (94a) provided at one of the table (22) and a saddle (18) supporting the table (22), and a Hall element (94b) provided at the other of the table (22) and the saddle (18), the Hall element being configured to detect a strength of a magnetic field.

### <Third Invention>

A parameter setting method sets a parameter relating to a speed of a table (22) of a machine tool (10, 42, 52, 70) in accordance with the weight of an object placed on the table (22). The parameter setting method includes: an amount-of-strain obtaining step (S1) of obtaining the amount of strain of the table (22); and a parameter setting step (S3) of setting, by using a storage unit (38) storing the parameter corresponding to the amount of strain, the parameter based on the amount of strain obtained in the amount-of-strain obtaining step (S1) with the table (22) standing still.

Thus, it is possible to automatically set a parameter relating to the speed of the table (22) of the machine tool (10, 42, 52, 70) in a manner appropriate for the weight of the objects placed thereon, without moving the table (22). This makes it possible to perform a suitable speed control of the table (22) in accordance with the weight of the objects placed thereon. This in turn makes it possible to optimize the machining cycle time, improve the machining accuracy to the workpiece (W) without damaging the machine tool (10, 42, 52, 70), and to lengthen the life of the machine tool (10, 42, 52, 70).

The parameter may include at least one of a time constant and a maximum speed.

The present invention is not particularly limited to the embodiment described above, and various modifications are possible without departing from the essence and gist of the present invention.

What is claimed is:

1. A parameter setting device that is configured to set a parameter relating to a speed of a table of a machine tool in accordance with a weight of an object placed on the table, the device comprising:
an amount-of-strain obtaining unit configured to obtain an amount of strain of the table;
a storage unit that stores the parameter corresponding to the amount of strain; and
a parameter setting unit configured to set, by using the storage unit, the parameter based on the amount of strain obtained by the amount-of-strain obtaining unit with the table standing still.

2. The parameter setting device according to claim 1, wherein the parameter includes at least one of a time constant and a maximum speed.

3. The parameter setting device according to claim 1, wherein
the amount-of-strain obtaining unit is configured to obtain the amounts of strain at multiple positions of the table, and
the parameter setting unit is configured to set the parameter in accordance with an average value of the amounts of strain at the multiple positions.

4. A system comprising:
the parameter setting device according to claim 1; and
a driving control unit configured to perform a speed control of the table based on the parameter set by the parameter setting unit.

5. The system according to claim 4, wherein the system is the machine tool.

6. The system according to claim 5, wherein a numerical control device of the machine tool includes the parameter setting device and the driving control unit.

7. The system according to claim 5, wherein a numerical control device of the machine tool includes the driving control unit, and a control device different from the numerical control device includes the parameter setting device.

8. The system according to claim 4, further comprising a plurality of the machine tools each including a numerical control device,
wherein each of the numerical control devices includes the driving control unit, and
the numerical control device of one of the plurality of the machine tools includes the parameter setting device.

9. The system according to claim 4, further comprising a plurality of the machine tools each including a numerical control device,
wherein each of the numerical control devices includes the driving control unit, and
a control device different from the numerical control devices includes the parameter setting device.

10. The system according to claim 4, wherein the amount-of-strain obtaining unit is configured to obtain the amount of strain based on a measurement value measured by a measurement unit provided in the machine tool.

11. The system according to claim 10, wherein the measurement unit comprises an air micro sensor, a contact sensor, a strain gauge sensor, or a vision camera.

12. The system according to claim 10, wherein the measurement unit includes a magnet provided at one of the table and a saddle supporting the table, and a Hall element provided at another of the table and the saddle, the Hall element being configured to detect a strength of a magnetic field.

13. A parameter setting method for setting a parameter relating to a speed of a table of a machine tool in accordance with a weight of an object placed on the table, the method comprising:
an amount-of-strain obtaining step of obtaining an amount of strain of the table; and
a parameter setting step of setting, by using a storage unit storing the parameter corresponding to the amount of strain, the parameter based on the amount of strain obtained in the amount-of-strain obtaining step with the table standing still.

14. The parameter setting method according to claim 13, wherein the parameter includes at least one of a time constant and a maximum speed.
